(19) United States
(12) Patent Application Publication
(10) Pub. No.: US 2012/0089309 A1
(43) Pub. Date: Apr. 12, 2012

(54) VEHICLE CONTROL DEVICE

(75) Inventors: Jonggap Kim, Shizuoka-ken (JP); Katsumi Kono, Aichi-ken (JP)

(73) Assignee: Toyota Jidosha Kabushiki Kaisha, Toyota-shi, Aichi (JP)

(21) Appl. No.: 13/377,662

(22) PCT Filed: Jun. 12, 2009
(86) PCT No.: PCT/JP2009/002682

§ 371 Date: Dec. 12, 2011

(51) Int. Cl. F02D 41/12; F16H 59/48

(52) U.S. Cl. 701/58; 701/103

(57) ABSTRACT

A vehicle control device includes an accelerator pedal adjusted in degree of operation, thereby adjusting power generated by an engine as a power source when running a vehicle. In the vehicle control device, in order to enhance fuel economy more reliably, fuel cut is carried out when the degree of operation of the accelerator pedal is other than zero, that is, when an accelerator is not fully opened and the vehicle is decelerating, the fuel cut that is the control in which supply of fuel used for operating the engine is stopped. Thus, even if the accelerator is not fully closed, a quantity of fuel injected by a fuel injector, and hence fuel consumption can be reduced. Accordingly, fuel economy can be enhances more reliably.

### FIELD

The present invention relates to a vehicle control device. In particular, the present invention relates to a vehicle control device that controls fuel cut.

### BACKGROUND

A vehicle control device adjusts engine output generally by adjusting volume or ratio of mixed gases to be supplied to the engine according to the operation of an accelerator pedal. Thereby, the vehicle can generate driving force requested by a driver and run in desired running condition. In order to improve ease of driving, some conventional vehicle control devices exert control that yields a deceleration by operation of the accelerator pedal. For example, the vehicle deceleration control device described in the Patent Literature 1 causes a braking device to generate braking force when the accelerator pedal is returned if the accelerating operation area falls in areas other than those where the engine output is minimum, such as areas other than that where fuel cut, which is control that stops the supply of fuel to the engine, is carried out. Alternatively, if the operated position to which the accelerator pedal is closed goes beyond the operated position requiring fuel cut, a higher deceleration is yielded by carrying out fuel cut.

The vehicle deceleration control device described in Patent Literature 1 is thus able to generate braking force by operation of the accelerator pedal and also yields a deceleration by carrying out fuel cut. This eliminates the need frequently and selectively to step accelerator and brake pedal when the vehicle is running. As a result, ease of driving when running the vehicle is improved. Additionally, carrying out fuel cut when the vehicle is running yields a deceleration and enhances fuel economy as well.

### CITATION LIST

### Patent Literature

Patent Literature 1: Japanese Patent Application Laid-open No. 2001-219831

### SUMMARY

### Technical Problem

When the vehicle is running, there is a case in which fuel cut is carried out, as described above, fuel cut is carried out especially to reduce fuel consumption and enhance fuel economy. Compared to this, the vehicle deceleration control device described in Patent Literature 1 carries out fuel cut when the operating position of the accelerator pedal as it is being returned is closed beyond the operating position carrying out fuel cut. The vehicle deceleration control device described in Patent Literature 1 carries out fuel cut for the purpose of yielding a deceleration. Therefore, even when fuel cut is carried out based on the operating position of the accelerator pedal as described above, a deceleration is yielded by carrying out fuel cut, and thus the purpose is achieved.

However, when fuel cut is carried out based on the operating position of the accelerator pedal as a reference, there is an area where fuel cut is not carried out in the acceleration operation area. Therefore, if the vehicle is running for a long time where the operating position of the accelerator pedal is in an area not carrying out fuel cut, there is little prospect of a reduction in fuel economy. To counteract this, an operating position for carrying out fuel cut is set and when the accelerator pedal is closed beyond this operating position, fuel cut is carried out. In this case, if a reduction in fuel economy is dealt with first, the desired fuel economy is not obtained.

The present invention has been proposed in view of the foregoing drawbacks. Accordingly, it is an object of the present invention to provide a vehicle control device capable of more reliably enhancing fuel economy.

### Solution to Problem

A vehicle control device according to the present invention includes a power adjusting unit capable of adjusting power generated by an engine as a power source when a vehicle is running by adjusting degree of operation of the power adjusting unit, wherein when the degree of operation of the power adjusting unit is other than zero and when the vehicle is decelerating, fuel supply stopping control, in which supply of fuel used for operating the engine is stopped, is exerted.

Further, it is preferable to further include a transmission state altering mechanism capable of altering a transmission state of power between the engine and driving wheels, wherein the transmission state altering mechanism is preferably controlled such that when the fuel supply control is exerted, a transmission rate at which the power is transmitted between the engine and the driving wheels is decreased.

Further, it is preferable that when a road on which the vehicle is running is an upward slope, the fuel supply stopping control is inhibited.

Further, it is preferable that when the degree of operation of the power adjusting unit is increasing, the fuel supply stopping control is inhibited.

Further, it is preferable to further include a transmission state altering mechanism capable of altering a transmission state of power between the engine and the driving wheels; and a motor that is a power source for running the vehicle, wherein when the fuel supply stopping control is exerted, the transmission state altering mechanism is preferably controlled such that a transmission rate at which the power is transmitted between the engine and the driving wheels is decreased, and the motor is preferably configured such that if the transmission rate at which the power is transmitted between the engine and driving wheels is decreased by the transmission state altering mechanism during the fuel supply stopping control, with a result that rotation number of the engine has decreased to a fuel supply resuming engine speed or lower, the power required to independently operate the engine when resuming the fuel supply after the fuel supply stopping control can be transmitted to the engine.

### Advantageous Effects of the Invention

The vehicle control device according to the present invention yields advantageous effects that more reliably enhance fuel economy.

### BRIEF DESCRIPTION OF DRAWINGS

FIG. 1 is a schematic diagram of a vehicle control device according to an embodiment of the present invention.

FIG. 2 is a diagram of the configuration of main part of the vehicle control device illustrated in FIG. 1.

FIG. 3 is a diagram illustrating a comparison between the vehicle control device according to the embodiment and conventional vehicle control device in terms of deceleration and fuel cut when a vehicle is decelerating.

FIG. 4 is a diagram illustrating an area where fuel cut is carried out.

FIG. 5 is a diagram illustrating acceleration yielded according to an accelerator opening degree.

FIG. 6 is a diagram illustrating a change in deceleration when changing speed during deceleration.

FIG. 7 is a diagram illustrating slip control for frictional engagement elements during fuel cut.

FIG. 8 is a diagram illustrating slip control relative to brake cylinder pressure when the accelerator is fully closed.

FIG. 9 is a flowchart illustrating the processing procedure of the vehicle control device according to the embodiment.

FIG. 10 is a diagram of the main part of a modified example of the vehicle control device according to the embodiment.

FIG. 11 is a diagram illustrating an acceleration generated according to the accelerator opening degree in the vehicle control device illustrated in FIG. 10.

### DESCRIPTION OF EMBODIMENTS

Embodiments according to the present invention will now be described in detail with reference to the accompanying drawings. Meanwhile, the present invention is not limited to the embodiments. Further, components in the embodiment include components that can be easily conceived by a person skilled in the art or substantially the same components.

### Embodiment

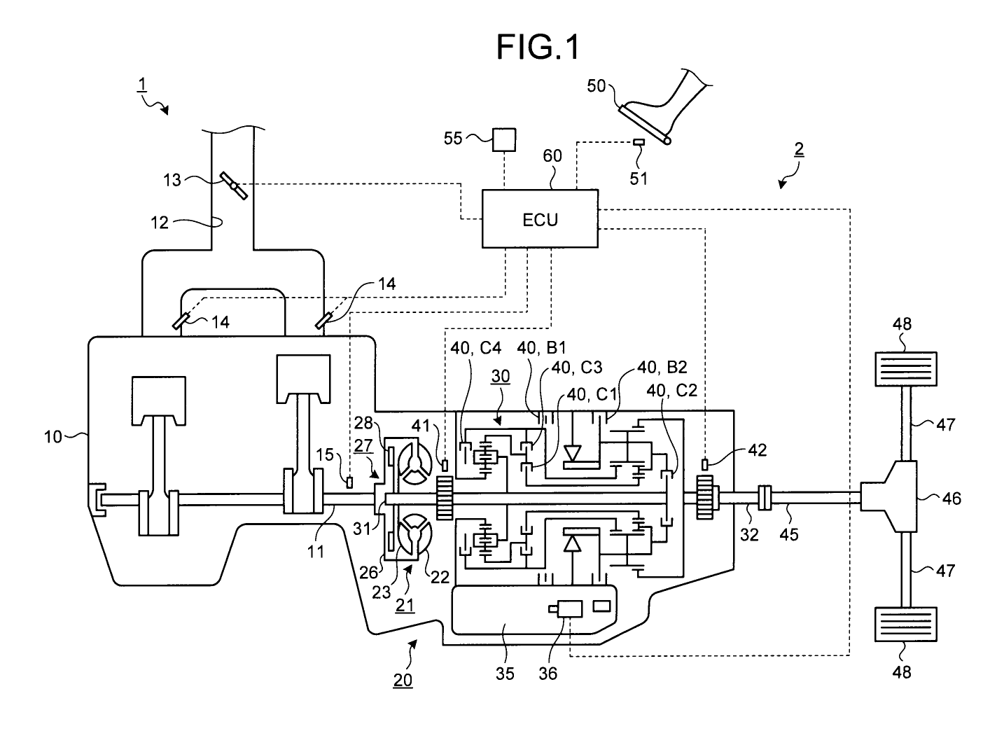

FIG. 1 is a schematic diagram of a vehicle control device according to an embodiment of the present invention. A vehicle control device 2 illustrated in FIG. 1 is able to exert control for an engine 10 provided as a power source during the running of a vehicle 1, and transmission control for an automatic transmission 20 connected to this engine 10. That is, both the engine 10 and automatic transmission 20 are connected to an ECU (Electronic Control Unit) 60, which is able to exert control of the speed and torque (output) of the engine 10 and transmission control for the automatic transmission 20.

Connected to the engine 10 are: an intake passage 12 communicating with a combustion chamber (not illustrated) of the engine 10 and used as a passage where air taken into the combustion chamber flows; and an exhaust passage (not illustrated) where exhaust gas discharged from the combustion chamber as a result of burning fuel in the combustion chamber flows. The intake passage 12 is provided with: a throttle valve 13, which is an intake air quantity adjusting means for adjusting a quantity of air taken into the engine 10; and a fuel injector 14, which is a fuel supply means for injecting fuel to be supplied to the combustion chamber. Both the throttle valve 13 and fuel injector 14 are connected to the ECU 60 and are able to be controlled by the ECU 60.

The automatic transmission 20 includes a torque converter 21, a transmission 30 and a hydraulic control device 35. Power generated in the engine 10 and input to the automatic transmission 20 can be transmitted to the transmission 30, which is a transmission ratio varying means, via the torque converter 21. When power from the engine 10 is transmitted to the transmission 30, the engine speed is changed at a transmission ratio selected by the transmission 30 according to the running state of the vehicle 1, and variable speed torque can be output to driving wheels 48 side of the vehicle 1.

The torque converter 21 has a pump 22 and a turbine 23, which are able to transmit power in fluid form transmitted from the engine 10. Further, the torque converter 21 has a lockup mechanism 27 able to mechanically transmit power transmitted from the engine 10. The lockup mechanism 27 includes: a cover 26 rotatable with the pump 22, and a lockup clutch 28 provided so as to be rotatable with a transmission input shaft 31, which is an input shaft for the transmission 30, and switchable between engagement with and disengagement from the cover 26.

Additionally, the transmission 30 of the automatic transmission 20 is a multistage transmission 30 composed by combining a plurality of planetary gear devices, which are transmitting elements, and a plurality of frictional engagement elements 40 (clutch C1, clutch C2, clutch C3, clutch C4, and brakes B1 and B2). Here, the brakes are the frictional engagement elements 40 attached to the housing of the transmission 30. The clutches are frictional engagement elements 40 attached to a rotary shaft, not to the housing of the transmission 30. The number of the transmitting elements and the frictional engagement elements 40 in the transmission 30 may be changed as required according to the specification of the automatic transmission 20.

The hydraulic control device 35 has a linear solenoid valve 36, which is a frictional engagement element hydraulic adjusting means for adjusting the pressure of control oil to be supplied to each of frictional engagement elements 40. This hydraulic control device 35 is able to generate oil pressure for operating the frictional engagement elements 40 and has the function of distributing oil pressure thus generated to each predetermined frictional engagement element 40 and also the function of adjusting the pressure of control oil to be supplied to the frictional engagement element 40. Additionally, the automatic transmission 20 is provided with a pump (not illustrated) connected to the linear solenoid valve 36 and used to supply control oil, stored in the automatic transmission 20, to the linear solenoid valve 36.

The transmission 30 can change a transmission ratio by stopping the rotating elements (carriers and ring gears) of the planetary gear device, which are transmitting elements, by means of the brake B1, B2, or the like, which is the frictional engagement element 40, and then switching the rotating element of the transmission 30, to which power from the engine 10 is input, by means of the clutch C1, C2, C3, C4, or the like, which is the frictional engagement element 40. Also, a transmission gear stage can be changed by changing the combination of rotating elements to be stopped. That is, each combination of rotating or stopping rotating elements is set as a transmission gear stage for the automatic transmission 20. The automatic transmission 20 has a plurality of transmission gear stages able to change an engine speed corresponding to power transmitted from the engine 10.

The automatic transmission 20 is provided as described above, and, accordingly, power generated by the engine 10 is input to the transmission 30 of the automatic transmission 20 via the torque converter 21. The transmission 30 also has a transmission output shaft 32, which is an output shaft for the transmission 30. The transmission output shaft 32 is connected to a propeller shaft 45 of the vehicle 1. That is, the transmission output shaft 32 serves as an output shaft for the automatic transmission 20. Further, the propeller shaft 45 is connected to a differential device 46, which is connected to the driving wheels 48 of the vehicle 1 via driving shafts 47. Accordingly, power from the engine 10, transmitted to the automatic transmission 20, can be transmitted to the driving wheels 48 via the differential device 46 and the driving shafts 47.

The engine 10 is provided with an engine speed sensor 15, which is an engine speed detecting means able to detect the rotation number of an engine output shaft 11. Additionally, the automatic transmission 20 is provided with a transmission input shaft rotation number sensor 41, which is a transmission input shaft rotation number detecting means able to detect the rotation number of the transmission input shaft 31, and a transmission output shaft rotation number sensor 42, which is a transmission output shaft rotation number detecting means able to detect the rotation number of the transmission output shaft 32.

The engine speed sensor 15, the transmission input shaft rotation number sensor 41, the transmission output shaft rotation number sensor 42, and a linear solenoid valve 36 are all connected to the ECU 60. Provided at the driver's seat of the vehicle 1 is an accelerator pedal 50, which is a power adjusting unit able to adjust power generated by the engine 10, by adjusting an accelerator opening degree, i.e., the degree of operation. Provided near the accelerator pedal 50 is an accelerator opening-degree sensor 51, which is a power adjusting unit operating-degree detecting means able to detect the accelerator opening degree. This accelerator opening-degree sensor 51 is also connected to the ECU 60. Furthermore, connected to the ECU 60 is an acceleration sensor 55, which is an acceleration detecting means for detecting the acceleration of the vehicle 1 while running.

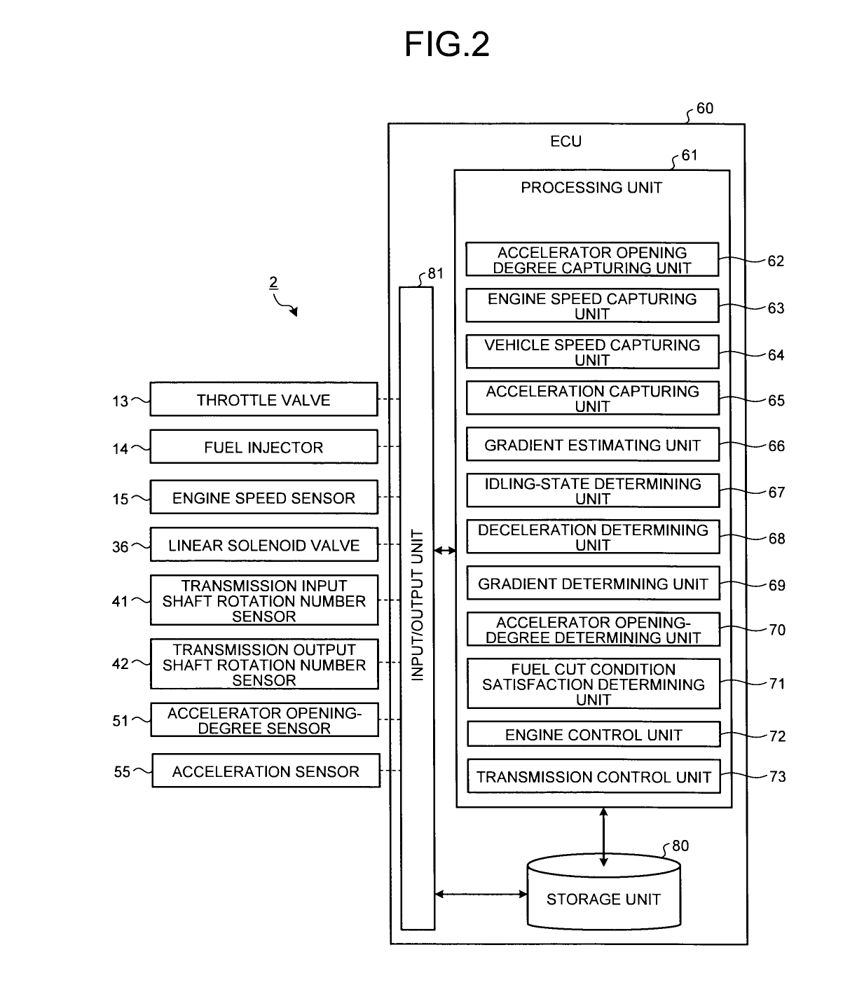

FIG. 2 is a diagram of the configuration of the main part of the vehicle control device illustrated in FIG. 1. The ECU 60 is provided with a processing unit 61, a storage unit 80, and an input/output unit 81. They can be connected to one another and transfer/receive signals to/from one another. The throttle valve 13, the fuel injector 14, the engine speed sensor 15, the linear solenoid valve 36, the transmission input shaft rotation number sensor 41, the transmission output shaft rotation number sensor 42, and the accelerator opening-degree sensor 51, and the acceleration sensor 55 are connected to the input/output unit 81. The input/output unit 81 inputs/outputs signals from/to those such as the engine speed sensor 15. The storage unit 80 stores a computer program for controlling the vehicle control device 2.

The processing unit 61 is composed of memory and a CPU (Central Processing Unit). The processing unit 61 includes at least: an accelerator opening-degree capturing unit 62, which is an accelerator opening-degree capturing means able to capture the accelerator opening degree, i.e., the degree to which the accelerator pedal 50 is open, from a result detected by the accelerator opening-degree sensor 51; an engine speed capturing unit 63, which is an engine speed capturing means for capturing the speed of the engine from the result detected by the engine speed sensor 15; a vehicle speed capturing unit 64, which is a vehicle speed capturing means for capturing a vehicle speed from a result detected by the transmission output shaft rotation number sensor 42; an acceleration capturing unit 65, which is an acceleration capturing means for capturing the acceleration of the vehicle 1 from the result detected by the acceleration sensor 55; and a gradient estimating unit 66, which is a slope estimating means for estimating the slope of a road on which the vehicle 1 is running, based on, for example, the accelerator opening degree, obtained by the accelerator opening-degree capturing unit 62, and the acceleration, captured by the acceleration capturing unit 65.

The processing unit 61 also includes: an idling-state determining unit 67, which is an idling-state determining means for determining, based on the accelerator opening degree, captured by the accelerator opening-degree capturing unit 62, whether the accelerator pedal 50 is in an idling-off state other than the completely closed state of the accelerator pedal 50; a deceleration determining unit 68, which is a deceleration determining means for determining, based on the vehicle speed captured by the vehicle speed capturing unit 64, whether the vehicle 1 is decelerating or not; a gradient determining unit 69, which is a slope determining means for determining, based on the slope determined by the gradient estimating unit 66, whether the road on which the vehicle running is an upward slope or not; an accelerator opening-degree determining unit 70, which is a power adjusting unit operating-degree determining means for determining, based on the accelerator opening degree, captured by the accelerator opening-degree capturing unit 62, change in the accelerator opening degree, i.e., the degree to which the accelerator pedal 50 is operated; and a fuel cut condition satisfaction determining unit 71, which is a fuel cut conditions satisfaction determining means for determining whether fuel cut conditions, i.e., conditions for carrying out fuel cut, have been satisfied or not.

Additionally, the processing unit 61 includes: an engine control unit 72, which is an internal combustion engine control means for exerting operation control of the engine 10; and a transmission control unit 73, which is a hydraulic control means for exerting transmission control of the automatic transmission 20 by controlling the oil pressure applied to the frictional engagement element 40 of the automatic transmission 20.

The vehicle control device 2 is controlled by the ECU 60 such that, based on results detected by, for example, the accelerator opening-degree sensor 51, and so on, the processing unit 61 reads the computer program into memory incorporated in the processing unit 61 in order to perform arithmetical operations, and actuates the linear solenoid valve 36 and so on according to the result of the arithmetic operation. At this time, as required, the processing unit 61 stores a numeric value/values into the storage unit 80 in course of the arithmetic operation, or retrieves a stored numeric value/values and performs the arithmetic operation. Where the vehicle control device 2 is controlled in such a manner, dedicated hardware, which is different from the ECU 60, may control the vehicle control device 2 instead of the above computer program.

The vehicle control device 2 according to the embodiment has the foregoing configuration, and operation thereof will now be described. While the vehicle 1 is running, a stroke amount of the accelerator pedal 50, or the accelerator opening degree, is detected by the accelerator opening-degree sensor 51 provided near the accelerator pedal 50. The result detected by the accelerator opening-degree sensor 51 is transmitted to and received by the accelerator opening-degree capturing unit 62 of the processing unit 61 of the ECU 60. The accelerator opening degree, captured by the accelerator opening-degree capturing unit 62, is transmitted to the engine control unit 72 of the processing unit 61 of the ECU 60. The engine control unit 72 controls the engine 10 based on the transmitted accelerator opening degree and based on results detected by other sensors.

Specifically, based on, for example, the accelerator opening degree, captured by the accelerator opening-degree capturing unit 62, the engine control unit 72 controls the degree to which the throttle valve 13 is open and the quantity of fuel to be injected from the fuel injector 14. Thus, based on, for example, the accelerator opening degree, the engine control unit 72 adjusts the quantity and the mixing ratio of mixed gases to be taken into the combustion chamber of the engine 10, and causes the engine 10 to generate the power required by the driver.

Power from the engine 10 controlled by the engine control unit 72 is output to external portions by rotation of the engine output shaft 11. Rotation of the engine output shaft 11 is first transmitted to the torque converter 21. Consequently, the torque converter 21 rotates, and its rotations are transmitted to the transmission input shaft 31 via the torque converter 21.

The rotations of the engine output shaft 11, transmitted to the transmission input shaft 31 via the torque converter 21, are transmitted to the transmission 30 via the transmission input shaft 31. Thereby, power from the engine 10 is input to the transmission 30.

The engine speed and torque magnitude of power from the engine 10, thus input from the transmission input shaft 31 to the transmission 30 via the torque converter 21, are modified by the transmitting elements of the transmission 30, and the modified power is output from the transmission output shaft 32 of the transmission 30. This transmission output shaft 32 is connected to the propeller shaft 45 of the vehicle 1 and, therefore, output from the transmission 30 is transmitted to the driving wheels 48 of the vehicle 1 via the propeller shaft 45 and other power transmitting means, such as the differential device 46, disposed between the automatic transmission 20 and the driving wheels 48. As a result, the driving wheels 48 rotate and the vehicle 1 runs.

The transmission control unit 73 of the processing unit 61 of the ECU 60 controls the automatic transmission 20 while the vehicle 1 is running such that transmission control is exerted according to the running state of the vehicle 1. Specifically, while the vehicle 1 is running, the rotation number of the engine output shaft 11 is detected by the engine speed sensor 15, and the result thus detected is transmitted to and captured by the engine speed capturing unit 63 of the processing unit 61 of the ECU 60. Additionally, while the vehicle 1 is running, the rotation number of the transmission output shaft 32 is detected by the transmission output shaft rotation number sensor 42. The transmission ratio of the transmission output shaft 32 to the driving wheels 48 is constant. Accordingly, detection of the rotation number of the transmission output shaft 32 enables estimation of the rotation number of the driving wheels 48, and hence estimation of vehicle speed. Therefore, the transmission output shaft rotation number sensor 42 is provided as a vehicle speed detecting means able to detect vehicle speed by detecting the rotation number of the transmission output shaft 32. The rotation number of the transmission output shaft detected by this transmission output shaft rotation number sensor 42 is transmitted to the vehicle speed capturing unit 64 of the processing unit 61 of the ECU 60, and is subjected to a predetermined arithmetic operation by the vehicle speed capturing unit 64, and the result is obtained as a vehicle speed.

The transmission control unit 73 actuates the linear solenoid valve 36 according to the accelerator opening degree, captured by the accelerator opening-degree capturing unit 62, the engine speed, captured by the engine speed capturing unit 63, the vehicle speed, captured by the vehicle speed capturing unit 64, etc. Thereby, the frictional engagement elements 40, such as the clutch C1, are actuated to switch between the engagement and disengagement of the frictional engagement elements 40 and hence between rotation and stop of the rotating elements. Thus, the transmission ratio is changed to switch the transmission gear stage.

If the running state of the vehicle 1 while running satisfies the predetermined conditions, the engine control unit 72 of the processing unit 61 of the ECU 60 transmits a fuel injection stopping control signal to the fuel injector 14. As a result, the fuel injector 14 stops fuel injection, and a state of fuel cut is brought about, namely, fuel supply stopping control, which is control that stops the supply of fuel for operating the engine 10. While the fuel cut is being carried out, fuel is not supplied to the combustion chamber of the engine 10 but only air is taken into the combustion chamber according to the accelerator opening degree. As a result, power is not generated by the burning of fuel in the engine 10. However, force resulting from inertia produced when the vehicle 1 is running is transmitted to the engine 10 via the automatic transmission 20, etc. Thus, fuel cut is performed, so that even when power is not generated by the engine 10, the engine output shaft 11 rotates by means of force resulting from inertia produced when the vehicle is running, and portions such as the intake and exhaust valves (not illustrated), are also actuated by this force when the engine 10 operates.

When the vehicle 1 is running, fuel cut is carried out in such a manner if the predetermined conditions are satisfied. The conditions for fuel cut apply, for example, in the case where the degree of operation of the accelerator pedal 50 is zero, that is, the accelerator is fully closed and the engine has a predetermined engine speed or higher, or the case where, even if the accelerator is not fully closed, the road on which the vehicle 1 is running while decelerating is not an upward slope and the accelerator pedal 50 is not pressed further.

Specifically, if the accelerator is fully closed, it means that a driver is not requesting driving force. Additionally, in order to maintain the operating state of the engine 10 while the vehicle 1 is running, the engine control unit 72 maintains operation with a predetermined low rotation even when a driver is not requesting power from the engine 10 and hence force resulting from inertia produced while the vehicle 1 running is not transmitted to the engine 10. Therefore, the engine control unit 72 controls the degree to which the throttle valve 13 is open, so as to allow intake of the quantity of air required for this operation, and causes the fuel injector 14 to inject the fuel required for this operation. Thus, even when a driver is not requesting power and force resulting from inertia is not transmitted to the engine 10, the engine 10 operates using this air and fuel and carries out idling, which is a predetermined low speed operation. If the engine speed is equal to or lower than the predetermined speed even when the accelerator opening degree is fully closed, it is necessary to jet fuel for idling, as described above. Therefore, when the accelerator is fully closed, fuel cut is carried out when the engine speed is equal to or higher than the predetermined speed.

If the accelerator is not fully closed, acceleration, constant-speed running, or deceleration may be carried out according to, for example, the accelerator opening degree, vehicle speed, or transmission gear stage. However, fuel cut when the accelerator is not fully closed is carried out when the vehicle decelerates. Specifically, the situation in which the vehicle 1 is decelerating even when the accelerator is not fully closed means that the driver may request a decrease in driving force. Thus, this is a case in which fuel cut is carried out. When fuel cut is carried out in such a manner, the engine 10 does not burn fuel in the combustion chamber and hence power is not generated. As a result, in the vehicle control device 2 according to the embodiment, under the same conditions, the deceleration when fuel cut is carried out where the accelerator is not fully closed is higher than that where fuel cut is not carried out by conventional vehicle. These fuel cuts are carried out by the engine control unit 72 of the processing unit 61 of the ECU 60. The engine control unit 72 that controls the fuel cuts as described above is provided as a deceleration control means for carrying out fuel cut during deceleration of the vehicle 1 when the accelerator opening degree is not fully closed.

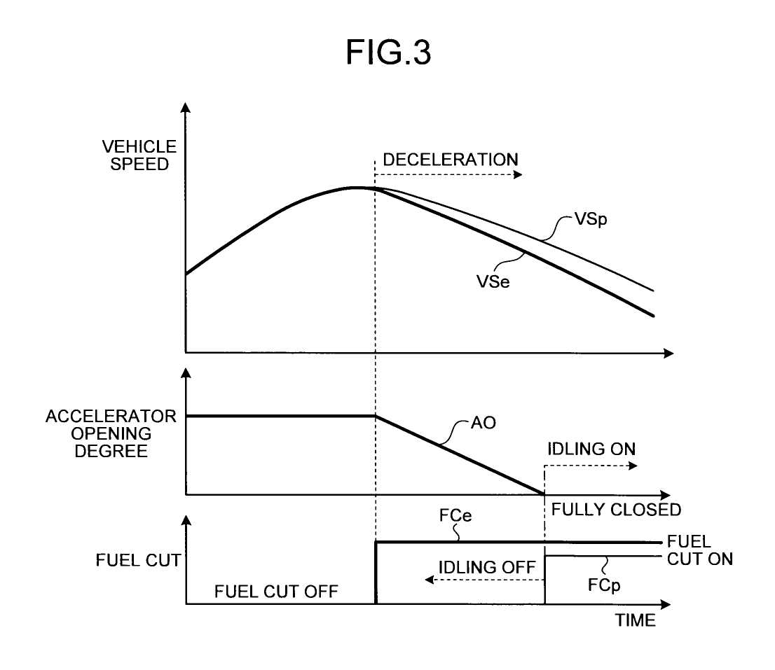

FIG. 3 is a diagram illustrating a comparison between the vehicle control device according to the embodiment and conventional vehicle apparatus in terms of deceleration and fuel cut when the vehicle is decelerating. As indicated by the fuel cut state FCp in FIG. 3, even when conventional vehicle control device has started decreasing vehicle speed and/or changing the accelerator opening degree AO to be zero, it does not carry out fuel cut until the accelerator opening degree AO is zero. In other words, conventional vehicle control device carries out fuel cut when the accelerator opening degree AO is zero.

Compared to this, as indicated by the embodiment fuel cut state FCe in FIG. 3, the vehicle control device 2 according to the embodiment carries out fuel cut when starting to change the accelerator opening degree AO is zero, thereby decreasing vehicle speed and starting deceleration. Accordingly, as indicated in FIG. 3 by the conventional vehicle speed VSp in deceleration control exerted by conventional vehicle control device and embodiment vehicle speed VSe in reduction control exerted by the vehicle control device 2 according to the embodiment, the vehicle control device 2 according to the embodiment decelerates with a higher deceleration than conventional vehicle apparatus exerting deceleration control. That is, the vehicle control device 2 according to the embodiment decelerates more quickly than conventional vehicle control exerting deceleration control.

When the accelerator is fully closed, one condition for the idling control of the engine 10 is satisfied. Accordingly, an idling-on state is brought about in this case. Compared to this, when the accelerator is not fully closed, the idle control of the engine 10 is not exerted, so that an idling-off state in which idling control is not exerted is brought about.

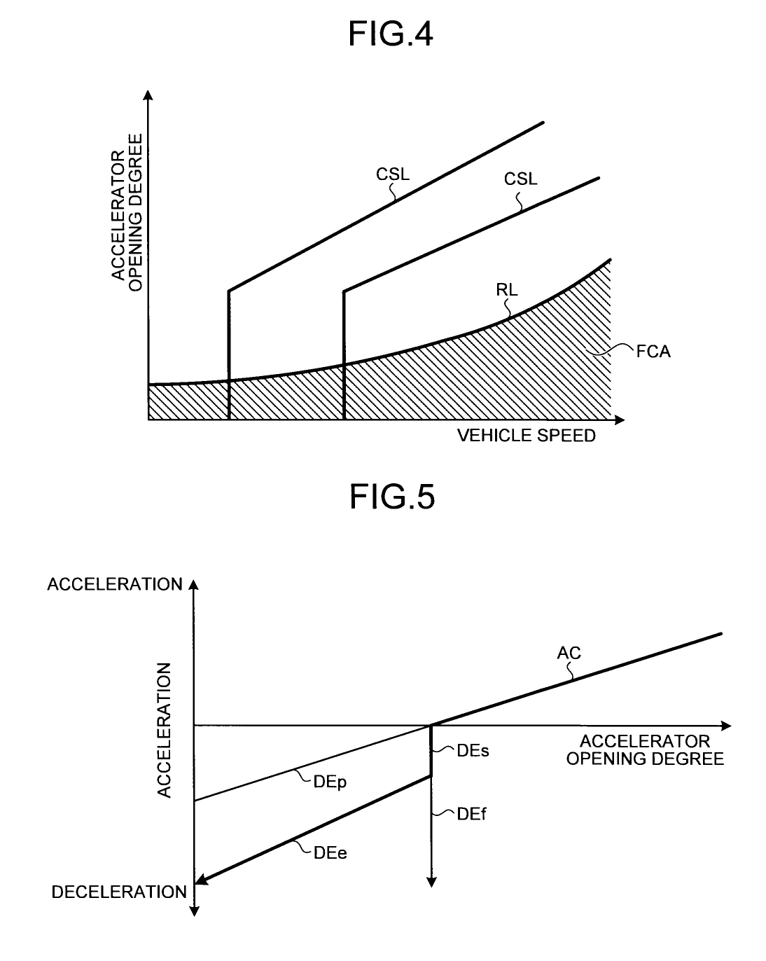

FIG. 4 is a diagram illustrating an area where fuel cut is carried out. Even when the accelerator is not fully closed, the vehicle control device 2 according to the embodiment carries out fuel cut if the vehicle 1 is decelerating. The accelerator opening degree and the change in speed of the vehicle 1 will now be explained. Power generated by the engine 10 is adjusted by adjusting the accelerator opening degree. Therefore, the vehicle speed increases or decreases mainly with the accelerator opening degree. Specifically, when the accelerator opening degree is increased, the vehicle 1 accelerates, and when the accelerator opening degree is decreased, it decelerates. As described above, by changing the accelerator opening degree, the vehicle speed increases or decreases. However, the boundary between these lies where the accelerator opening degree matches the driving force generated according to the accelerator opening degree and the road load, which is running resistance applied when the vehicle 1 is running.

Specifically, by changing the power of the engine 10 by adjusting the accelerator opening degree, the driving force of the vehicle 1 changes according to the power of this engine 10, the transmission gear stage of the automatic transmission 20, and vehicle speed. However, the acceleration changes according to the relation between the driving force, which changes in such a manner, and the road load. Specifically, when the driving force is significantly greater than the road load, acceleration increases. When the degree to which the driving force is greater than the road load is small, acceleration decreases. Further, if the driving force is less than the road load, the driving force yields to the road load and hence the vehicle 1 does not accelerate in an advancing direction, but decelerates. Thus, when the driving force is greater than the road load, the vehicle 1 accelerates, and when the driving force is less than the road load, the vehicle 1 decelerates.

Because of this, the fuel cut area FCA, i.e., the operating area where fuel cut is carried out, is the area where the driving force when the vehicle 1 is running is equal to or less than the road load RL. Additionally, this road load RL is a running resistance that also includes air resistance applied when the vehicle 1 is running. Therefore, the road load RL increases with vehicle speed. This makes it easier for the vehicle to fall into the fuel cut area FCA, which is the area where the driving force is equal to or less than the road load RL, with less driving force as vehicle speed increases.

The fuel cut area FCA is an area set based on the relation between the driving force and road load RL, as described above. This driving force, however, changes according to the accelerator opening degree. In other words, the fuel cut area FCA is the operating area where the accelerator opening degree results in driving force less than the road load RL. Therefore, the accelerator opening degree, which is used as a reference for determining whether to carry out fuel cut or not, (i.e., the accelerator opening degree, which enables the fuel cut), is able to generate a driving force suitable for the road load RL estimated according to at least the vehicle speed.

FIG. 5 is a diagram illustrating acceleration yielded according to the accelerator opening degree. The vehicle control device 2 according to the embodiment carries out fuel cut during deceleration even when the accelerator is not fully closed. However, when fuel cut is carried out, fuel is not burned in the combustion chamber and hence no power is generated. Consequently, so-called engine brake, which is decelerating force generated by rotation resistance of the engine 10, becomes greater compared to where fuel cut is not carried out. Therefore, in the vehicle control device 2 according to the embodiment, when fuel cut is carried out where the accelerator is not fully closed, the transmission control unit 73 of the processing unit 61 of the ECU 60 causes slippage of the clutch, and so on, which are provided in a power transmission system, such as the automatic transmission 20 transmitted between the engine 10 and the driving wheels 48 and which transmit power by means of frictional force. Thereby, the rate at which engine brake is applied to the driving wheels 48 is reduced. Specifically, when fuel cut is carried out where the accelerator is not fully closed, slippage of the frictional engagement elements 40, such as the clutch and brake, of the transmission 30 is caused, or slippage between the lockup clutch 28 and the cover 26 is caused when the lockup mechanism 27 of the torque converter 21 is being locked up.

The frictional engagement elements 40 of the transmission 30 and the lockup mechanism 27 of the torque converter 21 are provided as transmission state altering mechanisms, which can alter a state of the transmission of power between the engine 10 and the driving wheels 48 by causing slippage during power transmission. The transmission control unit 73 can control the transmission state altering mechanisms such as the frictional engagement elements 40, and is provided as a transmission state control means for controlling the frictional engagement elements 40 and the like so as to decrease the rate of power transmission between the engine 10 and the driving wheels 48 when the engine control unit 72 carries out fuel cut.

As illustrated in FIG. 5, the accelerator opening degree changes such that the acceleration AC increases with the accelerator opening degree, and decreases with the degree. Further, when the accelerator opening degree falls below that able to generate a driving force matching the road load RL, acceleration in the forward direction of the vehicle 1 becomes minus and deceleration is generated. When deceleration is thus generated, the degree of change in deceleration relative to the change in the accelerator opening degree is equal to the degree of change in the acceleration AC relative to the accelerator opening degree, as indicated by the conventional deceleration DEp in FIG. 5. Specifically, in conventional vehicle control device, when the accelerator is not fully closed, fuel is injected from the fuel injector 14, so that regardless of the relation between the accelerator opening degree and the road load, the engine 10 generates power according to the accelerator opening degree. For this reason, in conventional vehicle control device, the degree of change in conventional deceleration DEp, which is the deceleration relative to the change in the accelerator opening degree, is equal to the degree of change in the acceleration AC relative to the change in the accelerator opening degree.

Compared to this, in the vehicle control device 2 according to the embodiment, where the accelerator opening degree is less than that able to generate a driving force matching the road load, the deceleration suddenly increases from an accelerator opening degree that is greater than the road load to a point at which the accelerator opening degree matches the road load, as indicated by the embodiment deceleration DEe in FIG. 5.

In this case, when fuel cut is carried out when the accelerator pedal 50 is not fully closed, the engine 10 does not generate power, so that great engine brake is generated. As a result, where the frictional engagement elements 40 and so on are not caused to slip, the deceleration suddenly increases as indicated by the fuel cut period deceleration DEf in FIG. 5. However, when carrying out fuel cut during deceleration where the accelerator pedal 50 is not fully closed, the vehicle control device 2 according to the embodiment causes the frictional engagement elements 40 and so on to slip and, therefore, the rate at which engine brake is transmitted to the driving wheels 48 decreases. Accordingly, as indicated by the embodiment deceleration DEe, as the accelerator opening degree decreases, the deceleration increases so as to be lower than the fuel cut period deceleration DEf but higher than the conventional deceleration DEp.

When fuel cut is carried out, the engine 10 does not generate power. Therefore, when the frictional engagement elements 40 and so on are completely released, inertia produced when the vehicle 1 is running is not transmitted to the engine 10, which consequently stops. Therefore, even where fuel cut is carried out, the engine 10 has to be maintained at an engine speed that enables the engine 10 to resume operation independently when resuming after fuel cut. For this reason, when fuel cut is carried out during deceleration where the accelerator pedal 50 is not fully closed, the frictional engagement elements 40 and so on are engaged while slipping so that the force resulting from inertia produced when the vehicle 1 is running can be transmitted to the engine at least to a degree that this engine speed can be ensured. As a result, when fuel cut is carried out during deceleration where the accelerator pedal 50 is not fully closed, an engine speed ensuring deceleration DEs, which is a deceleration for ensuring the engine speed, is generated by means of the force resulting from inertia produced when the vehicle 1 is running, as indicated by the embodiment deceleration DEe.

In other words, in order to ensure an engine speed with which the engine 10 can resume operation independently after fuel cut, the frictional engagement elements 40 and so on are engaged while slipping. Thereby, some of the great engine brake generated as a result of fuel cut is transmitted to the driving wheels 48 by this engagement and hence engine speed ensuring deceleration DEs is generated. Independent operation of the engine 10 in this case does not refer to the state in which a crankshaft (not illustrated) rotates by means of inertia produced when the vehicle 1 is running, but refers to the state in which each operating part, such as a piston (not illustrated), operates by means of energy generated by the burning of fuel supplied to the engine 10, and consequently the crankshaft continuously rotates.

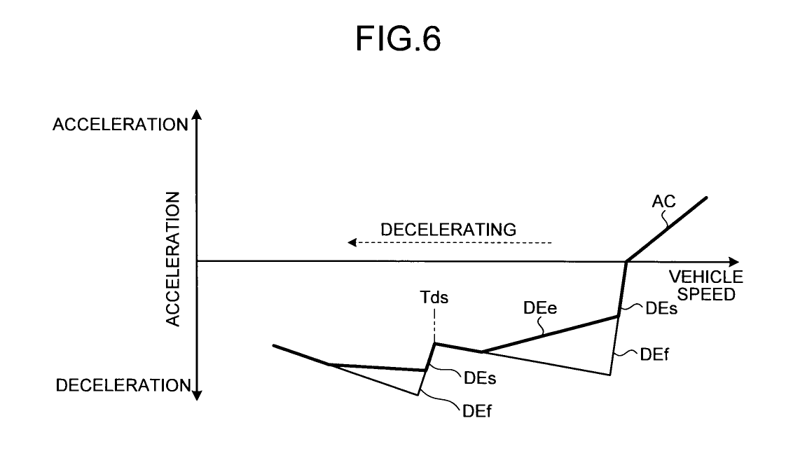

FIG. 6 is a diagram illustrating a change in deceleration when changing speed during deceleration. When fuel cut is carried out where the accelerator pedal 50 is not fully closed, the engine speed ensuring deceleration DEs is generated as described above. In this case, the frictional engagement elements 40 and the like are caused to slip. Accordingly, after generation of the engine speed ensuring deceleration DEs, the embodiment deceleration DEe becomes lower than the fuel cut period deceleration DEf, which is a deceleration assigned when the frictional engagement elements 40 and so on are not caused to slip.

Further, when the accelerator opening degree is decreased, the transmission control unit 73 causes the automatic transmission 20 to carry out transmission based on the relation between the vehicle speed and the accelerator opening degree. Specifically, the timing of transmission based on the relation between the accelerator opening degree and the vehicle speed is pre-set, as illustrated in the transmission line CSL in FIG. 4, and stored in the storage unit 80. According to the accelerator opening degree, captured by the accelerator opening-degree capturing unit 62, and the vehicle speed, captured by the vehicle speed capturing unit 64, the transmission control unit 73 controls the automatic transmission 20 and causes it to carry out transmission.

When the vehicle is decelerating, engine and vehicle speed decrease. When the engine speed becomes equal to or lower than a predetermined speed, transmission toward a low transmission gear stage takes place. However, when the engine speed decreases, engine brake weakens. Therefore, if the engine speed, captured by the engine speed capturing unit 63, decreases to a predetermined speed or lower, the transmission control unit 73 stops slipping of the frictional engagement elements 40 and so on, and causes them to engage with one another. When engine speed decreases, engine brake decreases; therefore, even where the frictional engagement elements 40 and so on are thus engaged, the decelerating force weakens.

If vehicle speed and hence engine speed further decrease in this state, the transmission control unit 73 exerts transmission control based the pre-set transmission line CSL. Specifically, when vehicle speed, engine speed, etc., reach an operating state for carrying out downshift, the transmission gear stage of the automatic transmission 20 is changed to a lower transmission gear stage. Where the transmission gear stage is changed in such a manner to a lower one at the time of downshift, Tds, engine speed and hence engine brake increase. Because of this, the transmission control unit 73 generates an engine speed ensuring deceleration DEs, then, causes the frictional engagement elements 40 and so on to slip, and makes the embodiment deceleration DEe lower than the fuel cut period deceleration DEf. Where engine speed has decreased as a result of a vehicle's deceleration in such a manner, engine speed is increased by carrying out downshift. Thereby, the rotation number of the engine 10 is prevented from dropping to or lower than fuel supply resuming engine speed, which is the engine speed at which the engine 10 is able to operate independently when resuming operation after fuel cut, that is, fuel cut resumption engine speed.

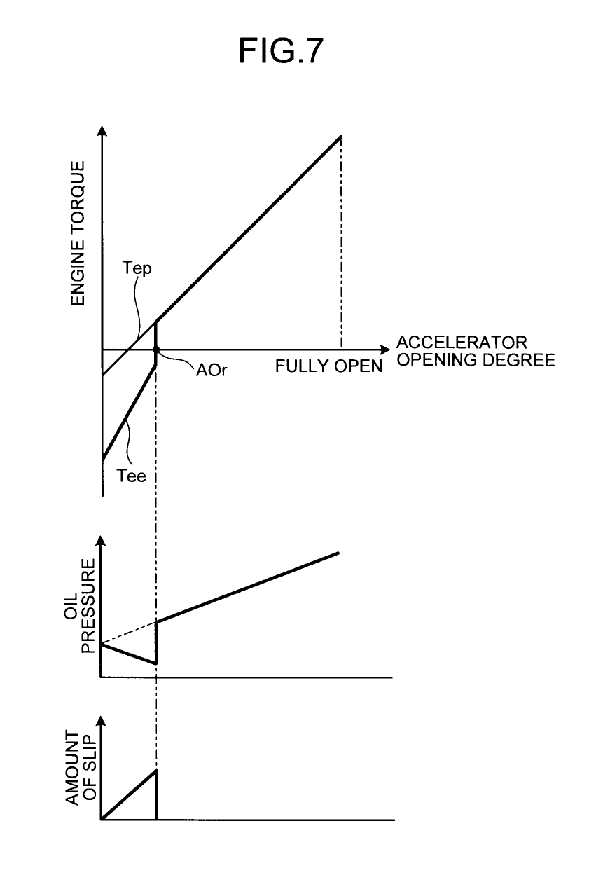

FIG. 7 is a diagram illustrating the slip control for frictional engagement elements during fuel cut. When fuel cut is carried out during deceleration where the accelerator pedal 50 is not fully closed, deceleration is adjusted by causing the frictional engagement elements 40 and so on to slip, as described above. Next, a description will be given of the slip control, as an example of control exerted when causing the frictional engagement elements 40 and so on of the automatic transmission 20 to slip.

When the accelerator opening degree is changed, engine torque transmitted to the driving wheels 48 is also changed. When the accelerator opening degree is changed using conventional vehicle control device, the engine torque decreases with the accelerator opening degree, as indicated by the conventional engine torque Tep in FIG. 7. This engine torque includes not only torque transmitted to the driving wheels 48 when the engine 10 is generating power, but also torque transmitted to the driving wheels 48 from the engine 10 as torque in the direction of deceleration of the vehicle 1 when engine brake is being generated.

Compared to this, where the vehicle control device 2 according to the embodiment exerts slip control while carrying out fuel cut during deceleration, the embodiment engine torque Tee, which is engine torque in slip control, suddenly decreases when becoming equal to or lower than the road load opening degree AOr, at which point the accelerator opening degree, which is being changed so as to decrease, matches the road load, as illustrated in FIG. 7. In this case, at the point in time when the accelerator opening degree equals or is lower than road load opening degree, the transmission control unit 73 suddenly decreases oil pressure applied to the frictional engagement elements 40 by means of the linear solenoid valve 36 and the hydraulic control device 35, which controls engagement and disengagement of the frictional engagement elements 40. Thereby, slippage of the frictional engagement elements 40 suddenly increases such that the engaged frictional engagement elements 40 slip in a short time.

After suddenly decreasing oil pressure applied to the frictional engagement elements 40, thereby causing in a short time the frictional engagement elements 40 to slip, the transmission control unit 73 increases oil pressure. Thereby, slippage decreases and the frictional engagement elements 40 change in the direction of engagement. When slippage becomes zero, the frictional engagement elements 40 are finally re-engaged.

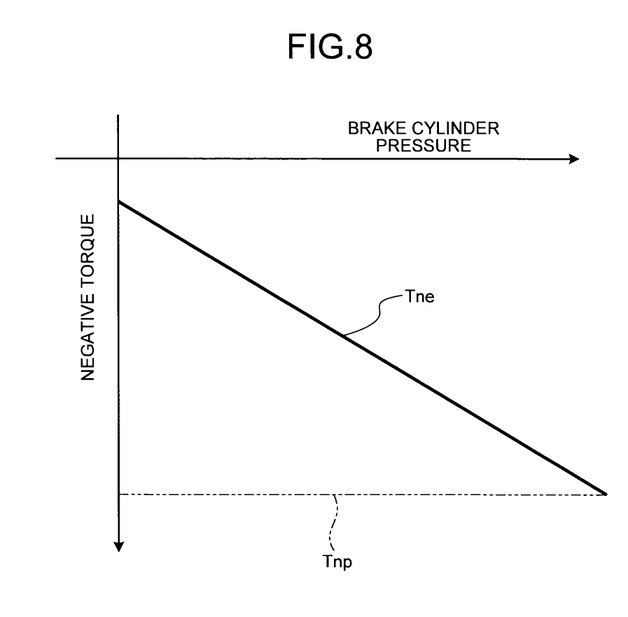

FIG. 8 is a diagram illustrating slip control relative to brake cylinder pressure when the accelerator is fully closed. As described above, when carrying out fuel cut during deceleration where the accelerator pedal 50 is not fully closed, the vehicle control device 2 according to the embodiment causes the frictional engagement element 40 and so on to slip. However, even when the accelerator pedal 50 is fully closed, the vehicle control device 2 according to the embodiment further carries out slip control of the frictional engagement elements 40 and so on during fuel cut. For example, where the possibility that the driver of the vehicle 1 intends to decelerate the vehicle is high, the frictional engagement elements 40 and so on are not caused to slip during fuel cut. Instead, negative torque, which is torque in the direction of deceleration generated by powerful engine brake generated as a result of fuel cut, is directly transmitted to the driving wheels 48. Conversely, when the possibility that the driver of the vehicle 1 intends to decelerate the vehicle is low, slippage caused by the frictional engagement elements 40 and so on is increased, thereby decreasing the rate at which negative torque is transmitted to the driving wheels 48.

The driver's intention to decelerate is determined based on, for example, the deceleration of the vehicle 1, or brake cylinder pressure, which is pressure generated in the mass cylinder (not illustrated) of a known brake device (not illustrated) by the driver's operating a brake pedal (not illustrated) provided next to the accelerator pedal 50. For example, if the driver's intention to decelerate is determined based on brake cylinder pressure, the transmission control unit 73 controls the frictional engagement elements 40 and so on such that negative torque transmitted to the driving wheels 48 increases with brake cylinder pressure, as indicated by the embodiment negative torque Tne in FIG. 8, i.e., such that torque in the direction of deceleration increases. That is, where brake cylinder pressure is high, it is determined that it is highly possible that the driver intends to decelerate. Therefore, in this case, slippage caused by the frictional engagement elements 40 and so on is minimized or made zero, thereby maximizing negative torque transmitted to the driving wheels 48 from the engine 10. In this case, negative pressure transmitted to the driving wheels 48 from the engine 10 substantially becomes equal to conventional negative torque Tnp, which is negative pressure transmitted to driving wheels 49 from the engine 10 when conventional vehicle control device carries out fuel cut where the accelerator is fully closed.

In conventional vehicle control device, as indicated by conventional negative torque Tnp in FIG. 8, negative torque transmitted to the driving wheels 48 from the engine 10 is constant in magnitude not only when brake cylinder pressure is high but also when it is low. Conventional negative torque is constant regardless of the magnitude of brake cylinder pressure.

Compared to this, in the vehicle control device 2 according to the embodiment, the rate at which the frictional engagement elements 40 and so on are caused to slip is increased as brake cylinder pressure decreases. As a result, because the rate at which negative torque is transmitted to the driving wheels 48 from the engine 10 decreases, the embodiment negative torque Tne decreases as the brake cylinder pressure decreases.

In this example, slip control of the frictional engagement elements 40 and so on is exerted such that negative torque transmitted to the driving wheels 48 increases as the brake cylinder pressure increases. However, exertion of slip control on the frictional engagement elements 40 and so on need not be based on brake cylinder pressure. Slip control of the frictional engagement elements 40 and so on suffices provided that transmission of power between the engine 10 and the driving wheels 49 is modified by the frictional engagement elements 40 and so on according to the deceleration requested by the driver, and the power transmission capacity can be modified according to the requested deceleration.

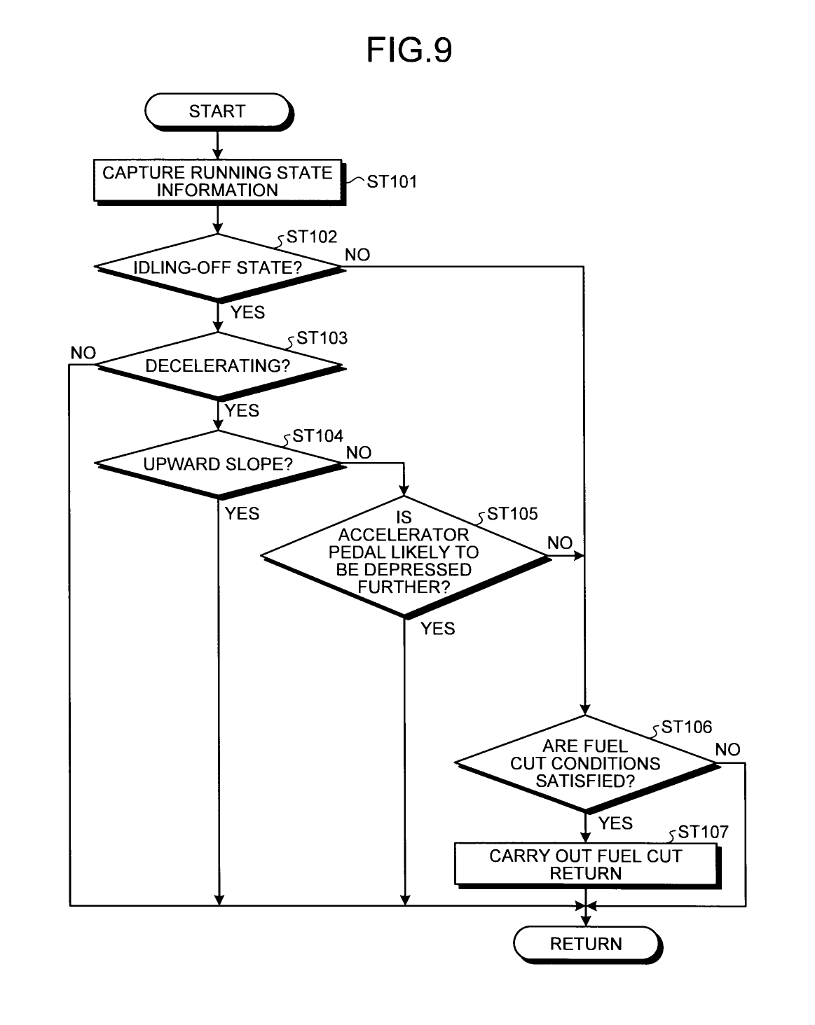

FIG. 9 is a flowchart illustrating the processing procedure of the vehicle control device according to the embodiment. Next will be described the control method of the vehicle control device 2 according to the embodiment, that is, the processing procedure of this vehicle control. The procedure below is called every predetermined period in order to control each part during operation of the vehicle 1. In the processing procedure of the vehicle control device 2 according to the embodiment, running state information is first captured (step ST101). In this case, for example, the accelerator opening degree, the degree to which the throttle valve 13 is open, water temperature, engine speed, vehicle speed, and acceleration when the vehicle is running are captured as running state information.

Of these, the accelerator opening degree is determined by the accelerator opening-degree sensor 51's detecting the degree to which the accelerator pedal 50 is open. The accelerator opening-degree capturing unit 62 captures the result of this determination. The engine speed is obtained by detecting the rotating speed of the engine output shaft 11 per unit time by use of the engine speed sensor 15, and the engine speed capturing unit 63 of the processing unit 61 of the ECU 60 captures the result of this detection as engine speed. Vehicle speed is obtained by detecting the rotating speed of the transmission output shaft 32 by use of the transmission output shaft rotation number sensor 42, and then the vehicle speed capturing unit 64 of the processing unit 61 of the ECU 60 captures the result of this detection and performs a predetermined arithmetic operation, obtaining vehicle speed as a result. The acceleration while the vehicle 1 is running is detected by the acceleration sensor 55, and the acceleration capturing unit 65 of the processing unit 61 of the ECU 60 captures the result of this detection.

Next, a determination is made whether the engine is in an idling-off state or not (step ST102). This determination is carried out by the idling-state determining unit 67 of the processing unit 61 of the ECU 60 based on the accelerator opening degree, captured by the accelerator opening-degree capturing unit 62. If the accelerator opening degree is captured by the accelerator opening-degree capturing unit 62 to be zero, one of the conditions for idling control of the engine 10 is satisfied, and the idling-state determining unit 67 therefore determines that the engine is in an idling-on state. If the accelerator opening degree is captured by the accelerator opening-degree capturing unit 62 not to be zero, idling control of the engine 10 is not exerted, and the idling-state determining unit 67 determines that the engine is in an idling-off state not subject to idling control. If the idling-state determining unit 67 determines that the engine is not in an idling-off state, the control flow proceeds to step ST106, which is described below.

Conversely, if the idling-state determining unit 67 determines that the engine is in an idling-off state (step ST102), the determination is next made whether the vehicle 1 is decelerating or not (step ST103). This determination is made by the deceleration determining unit 68 of the processing unit 61 of the ECU 60. The deceleration determining unit 68 captures, continuously or at brief predetermined intervals, vehicle speeds obtained by the vehicle speed capturing unit 64, and determines, based on the captured rate at which the speeds change, whether the vehicle 1 is decelerating or not. Specifically, if captured vehicle speed tends to decrease, the deceleration determining unit 68 determines that the vehicle 1 is decelerating and, if captured vehicle speed is constant or tends to increase, it determines that the vehicle 1 is not decelerating. If this deceleration determining unit 68 determines that the vehicle 1 is not decelerating, the control flow leaves this processing procedure. Incidentally, whether the vehicle 1 is decelerating or not does not have to be determined based on the rate at which vehicle speed changes, but may be made based on, for example, results detected by the acceleration sensor 55.

Conversely, if the deceleration determining unit 68 determines that the vehicle 1 is decelerating (step ST103), the determination is next made whether the road on which the vehicle is running is an upward slope or not (step ST104). This determination is made by the gradient determining unit 69 of the processing unit 61 of the ECU 60. When the gradient determining unit 69 seeks to determines whether the road on which the vehicle is running is an upward slope or not, the gradient estimating unit 66 of the processing unit 61 of the ECU 60 first estimates the gradient of the road on which the vehicle is running. To estimate the gradient of the road by use of the gradient estimating unit 66, an acceleration when the vehicle is assumed to be running on a road of gradient zero is first estimated from the accelerator opening degree captured by the accelerator opening-degree capturing unit 62, the vehicle speed captured by the vehicle speed capturing unit, and the engine speed captured by the engine speed capturing unit 63 or the current transmission gear stage selected by the transmission control unit 73. The gradient estimating unit 66 compares the thus estimated acceleration and the acceleration captured by the acceleration capturing unit 65, that is, the actual acceleration, and estimates the gradient of the road based on the difference between these.

That is, if the acceleration captured by the acceleration capturing unit 65 is higher than the acceleration estimated from the accelerator opening degree, and so on, it indicates that the acceleration of vehicle 1 is equal to or greater than driving force generated according to the accelerator opening degree, and so on. In this case, it is estimated that the gradient of the road is downward in the forward direction of the vehicle 1. Conversely, if the acceleration captured by the acceleration capturing unit 65 is lower than the acceleration estimated from the accelerator opening degree, and so on, it indicates that the acceleration of vehicle 1 is less than driving force generated according to the accelerator opening degree, and so on. In this case, it is estimated that the gradient of the road is upward in the forward direction of the vehicle 1.

Based on whether the gradient thus estimated by the gradient estimating unit 66 is an upward gradient or not in the forward direction of the vehicle 1, the gradient determining unit 69 determines whether the road on which the vehicle 1 is running has an upward gradient or not. If the gradient determining unit 69 determines that the road on which the vehicle is running has an upward gradient, the flow leaves this processing procedure.

Incidentally, the gradient of a road does not have to be estimated from the result detected by the acceleration sensor 55. Instead, for example, from the map information of a car navigation system (not illustrated) mounted in the vehicle 1, the gradient estimating unit 66 may estimate the gradient information of the road on which the vehicle 1 is currently running.

Conversely, if the gradient determining unit 69 determines that the road on which the vehicle is running is not an upward gradient (step ST104), it is determined whether the accelerator pedal 50 is likely to be depressed further or not (step ST105). This determination is made by the accelerator opening-degree determining unit 70 of the processing unit 61 of the ECU 60 based on the accelerator opening degree captured by the accelerator opening-degree capturing unit 62. The accelerator opening-degree determining unit 70 captures continuously or at brief predetermined intervals the accelerator opening degree according to the accelerator opening-degree capturing unit 62. If the accelerator opening degree tends to increase, the accelerator opening-degree determining unit 70 determines that the accelerator pedal 50 is likely to be depressed further. If the captured accelerator opening degree is constant or tends to close, the accelerator opening-degree determining unit 70 determines that the accelerator pedal 50 is unlikely to be depressed further. If the accelerator opening-degree determining unit 70 determines that the accelerator pedal 50 is likely to be depressed further, the flow leaves this processing procedure.

Conversely, if the accelerator opening-degree determining unit 70 determines that the accelerator pedal 50 is unlikely to be depressed further (step ST105) or the idling-state determining unit 67 determines that the vehicle is not in an idling-off state (step ST102), the determination is next made whether fuel cut conditions have been satisfied or not (step ST106). This determination is made by the fuel cut condition satisfaction determining unit 71 of the processing unit 61 of the ECU 60. The fuel cut condition satisfaction determining unit 71 determines whether the engine speed captured by the engine speed capturing unit 63 is equal to or higher than a predetermined engine speed or not, and also determines whether fuel cut conditions have been satisfied or not based on water temperature, vehicle speed, and other status values.

Specifically, if the engine speed captured by the engine speed capturing unit 63 is equal to or higher than a predetermined engine speed, the fuel cut condition satisfaction determining unit 71 determines that fuel cut conditions have been satisfied. If the engine speed captured by the engine speed capturing unit 63 is lower than a predetermined engine speed, the fuel cut condition satisfaction determining unit 71 determines that fuel cut conditions have not been satisfied. If the fuel cut condition satisfaction determining unit 71 determines that fuel cut conditions have not been satisfied, the flow leaves this processing procedure. Specifically, if the determination is thus made that fuel cut conditions have not been satisfied, fuel cut is not carried out. Therefore, if the gradient determining unit 69 determines that the road on which the vehicle 1 running is an upward slope or if the accelerator opening-degree determining unit 70 determines that the degree of operation of the accelerator pedal 50 is increasing, that is, if it determines that the accelerator pedal 50 is likely to be depressed further, the engine control unit 72 inhibits fuel cut, and injects fuel through the fuel injector 14 according to the running state of the vehicle 1.

Conversely, if the fuel cut condition satisfaction determining unit 71 determines that fuel cut conditions have been satisfied (step ST106), fuel cut is then carried out (step ST107). In this case, fuel cut is carried out by the engine control unit 72 of the processing unit 61 of the ECU 60. The engine control unit 72 carries out fuel cut by transmitting a control signal to the fuel injector 14, stopping the fuel injector 14 injecting fuel.

The foregoing vehicle control device 2 carries out fuel cut not only when the accelerator is fully closed, but also when the vehicle 1 is decelerating. Accordingly, the vehicle control device 2 is able to reduce fuel consumption. In other words, in conventional vehicle control device, the accelerator opening degree, when decreased, becomes lower than the accelerator opening degree that corresponds to road load, and the fuel injector 14 continues to inject fuel even when the vehicle 1 decelerates. Compared to this, in the vehicle control device 2 according to the embodiment, if the vehicle 1 decelerates to the degree where the accelerator is not fully closed, fuel cut is carried out by decreasing the accelerator opening degree. Accordingly, the amount of fuel injected by the fuel injector 14 and hence fuel consumption can be reduced by an amount corresponding to the fuel cut. As a result, fuel economy is more reliably enhanced.

To carry out fuel cut, the transmission control unit 73 controls the frictional engagement elements 40 and so on and causes these frictional engagement elements 40 to slip, thereby decreasing the rate at which power is transmitted between the engine 10 and the driving wheels 48, hence restraining excessive increases in deceleration during deceleration. That is, when fuel cut is carried out, the engine 10 does not generate power, with the result that the rate of deceleration easily increases compared to where fuel cut is not carried out. Therefore, if fuel cut is carried out where the accelerator is not fully closed, the deceleration during deceleration may exceed that expected by a driver. However, in that case, causing the frictional engagement elements 40 and so on to slip, thereby carrying out fuel cut, enables a reduction in the rate at which engine brake (which has increased as a result of fuel cut) is transmitted to the driving wheels 48. Accordingly, excessive increases in deceleration can be restrained when the vehicle is decelerating where the accelerator is not fully closed. As a result, the deceleration required by the driver can be obtained during deceleration while fuel economy is more reliably enhanced.

If the gradient determining unit 69 determines that the road on which the vehicle 1 is running is an upward slope even when the vehicle is decelerating where the accelerator is not fully closed, fuel cut is inhibited and not carried out. Accordingly, the vehicle 1 is restrained from decelerating needlessly. Specifically, on an upward slope, a vehicle requires greater driving force than when running on a flat road. As a result, the vehicle 1 may decelerate without the driver's intending to. In this case, if fuel cut is carried without a driver's intention to decelerate, the vehicle may decelerate needlessly. However, by inhibiting fuel cut in the case of an upward slope, deceleration without the driver's intending to can be restrained. Thus, while reduction in fuel economy is more reliably secured, the vehicle is restrained from decelerating needlessly or without the driver's intending to.

Additionally, if the accelerator opening-degree determining unit 70 determines that the accelerator opening degree is increasing even when the vehicle is decelerating where the accelerator is not fully closed, fuel cut is inhibited. Therefore, the vehicle 1 is restrained from decelerating needlessly. Specifically, if the accelerator opening degree is increasing, that is, if it is likely that the accelerator pedal 50 may be depressed further, even when the vehicle 1 is decelerating, it is estimated that the driver may intend to increase the speed of the vehicle 1. In this case, fuel cut is inhibited, thereby preventing the vehicle 1 from decelerating without the driver's intending to. As a result, while fuel economy is more reliably enhanced, the vehicle is prevented from decelerating needlessly regardless of a driver's intention to accelerate.

Additionally, when fuel cut is carried out where the accelerator is not fully closed, slip control of the frictional engagement elements 40 and so on, for example, is exerted according to the deceleration requested by a driver. Thereby, the power transmission capacity, when power is transmitted between the engine 10 and the driving wheels 48, is modified according to the rate of deceleration requested. Thus, the actual rate of deceleration during deceleration of the vehicle 1 can be continued at the rate of deceleration requested by a driver. As a result, while fuel economy is more reliably enhanced, deceleration matching a deceleration requested by a driver can be achieved.

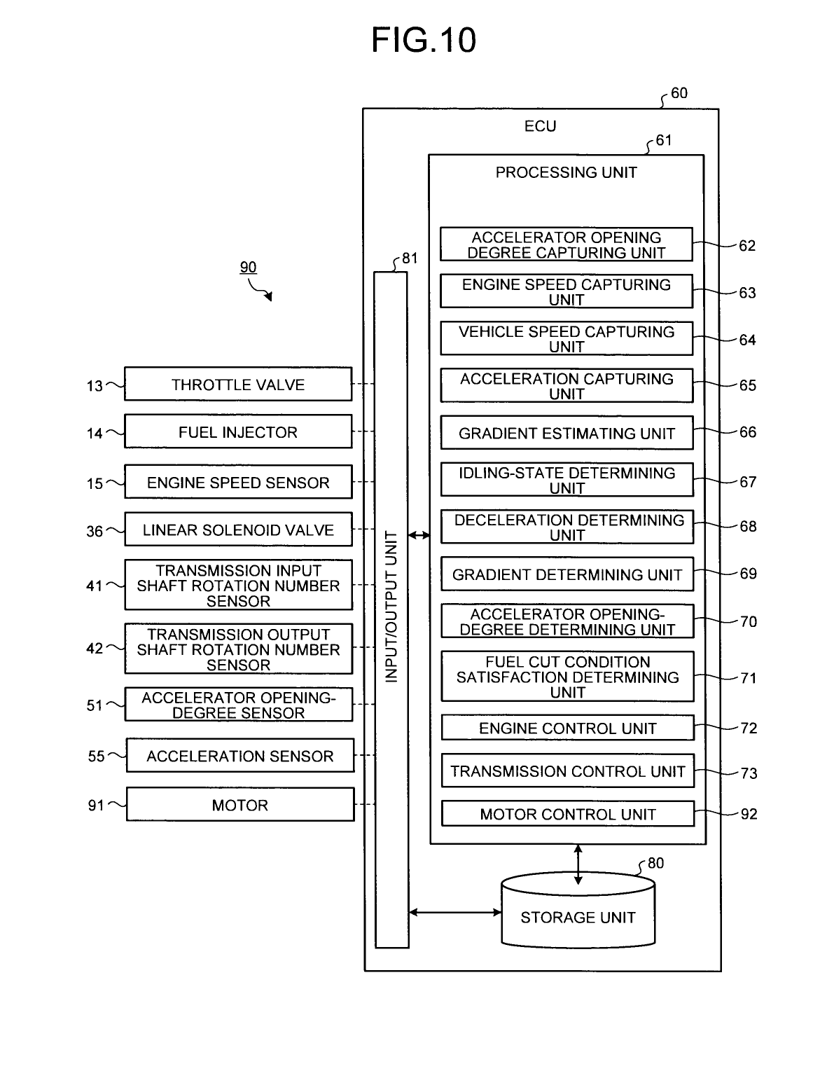

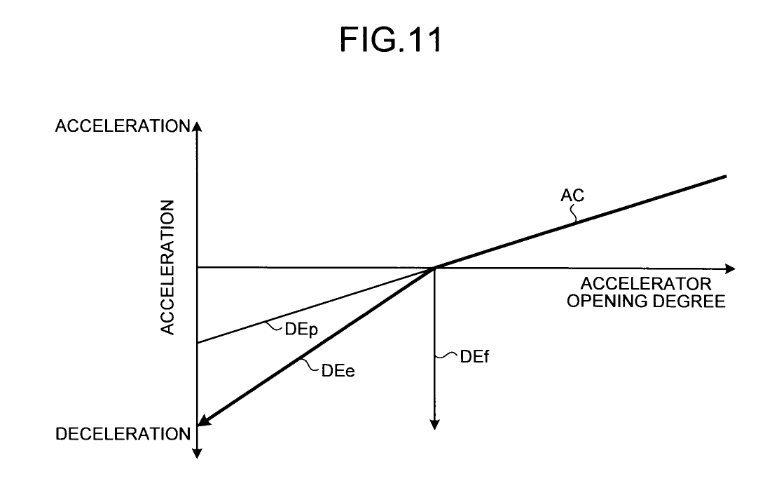

FIG. 10 is a diagram of the main part of a modified example of the vehicle control device according to the embodiment. FIG. 11 is a diagram illustrating, in the vehicle control device illustrated in FIG. 10, an acceleration generated according to the accelerator opening degree. In the foregoing vehicle control device 2, only the engine 10 is provided as a power source. However, in addition to the engine 10, a motor 91 operated by electricity may be provided as an additional power source. That is, the vehicle 1 equipped with a vehicle control device 90 may be equipped as a so-called hybrid vehicle, in which the engine 10 and the motor 91 are provided as power sources, and according to the running state of the vehicle 1 or driving force requested by a driver, their power is controlled and used as driving force for running the vehicle. Among the plurality of wheels of the vehicle 1, a motor 91 provided as a power source as described above may transmit power to wheels other than the ones to which the power of the engine 10 is transmitted. Alternatively, the motor 91 may be provided so as to be able to transmit power to the same wheels as those to which the power of the engine 10 is transmitted.

In addition to the engine 10, the vehicle control device 90 according to the modified example is provided with a motor 91 as a power source, as described above. Therefore, the processing unit 61 of the ECU 60 includes a motor control unit 92 for controlling the motor 91, in addition to the accelerator opening-degree capturing unit 62, the engine speed capturing unit 63, the vehicle speed capturing unit 64, the acceleration capturing unit 65, the gradient estimating unit 66, the idling-state determining unit 67, the deceleration determining unit 68, the gradient determining unit 69, the accelerator opening-degree determining unit 70, the fuel cut condition satisfaction determining unit 71, the engine control unit 72, and the transmission control unit 73. As described above, the motor 91 is provided as a power source in addition to the engine 10, and the ECU 60 is provided with the motor control unit 92. Thereby, while the vehicle 1 provided with the vehicle control device 90 according to the modified example is running, the engine 10 and the motor 91 are controlled by the engine control unit 72 and the motor control unit 92 respectively. Thus, according to the running state of the vehicle 1, and so on, driving force is generated either with the power of the engine 10 only, or with the power of the motor 91 only, or with a combination of the power of the engine 10 and the motor 91.

As in the vehicle control device 2 according to the embodiment, the vehicle control device 90 according to this modified example also carries out fuel cut when the vehicle is decelerating where the accelerator is not fully closed, and exerts the slip control of the frictional engagement elements 40 and so on by use of the transmission control unit 73 according to a deceleration requested by a driver. As a result, the fuel cut restrains the actual rate of deceleration from increasing excessively and brings the actual rate of deceleration close to that requested.

When fuel cut is carried out, power is not generated by the engine 10. Therefore, during fuel cut, the speed of the engine 10 is set so as to resume operation independently after fuel cut. Due to such engine speed, the vehicle control device 2 according to the embodiment slips and engages the frictional engagement elements 40 and so on such that the force resulting from inertia produced when the vehicle 1 is running is transmitted to a degree that ensures at least this engine speed. Therefore, if the vehicle control device 2 according to the embodiment carries out fuel cut when the vehicle 1 is running where the accelerator pedal 50 is not fully closed, the engine speed ensuring deceleration DEs, which is a rate of deceleration ensuring an engine speed is generated by force resulting from inertia produced when the vehicle 1 is running, as indicated by the embodiment deceleration DEe in FIG. 5.

Compared to this, the vehicle control device 90 according to the modified example can run the vehicle 1 with the power of the motor 91 even if the engine 10 stops due to fuel cut. Additionally, the power of the motor 91 can be transmitted to the engine 10 via the wheels to which the power of the engine 10 is transmitted or via a power transmission device, such as a known power transmission mechanism (not illustrated), interposed between the engine 10 and the motor 91. Thus, when the engine 10 is independently operated after fuel cut, even if the engine 10 stops due to fuel cut, the engine 10 can be independently operated by transmitting the power of the motor 91 to the engine 10, thereby rotating the engine output shaft 11.

Specifically, there may be a case where the rotation number of the engine 10 may decrease to the fuel cut resuming engine speed or lower when the rate at which power is transmitted between the engine 10 and the driving wheels 48 is decreased during fuel cut by controlling the frictional engagement elements 40 and so on by use of the transmission control unit 73. For this reason, in the vehicle control device 90 according to the modified example, the motor 91 is able to transmit to the engine 10 power required to increase the rotation number of the engine 10 up to a rotation number that enables the engine 10 to operate independently after fuel cut. Thus, unlike the vehicle control device according to the embodiment, it is unnecessary to slip and engage the frictional engagement elements 40 and so on in order to ensure an engine speed that enables the engine 10 to operate independently when fuel cut is carried out during deceleration where the accelerator is not fully closed.

Therefore, the vehicle control device 90 according to the modified example is able to carry out fuel cut without generating an engine speed ensuring deceleration DEs as in the vehicle control device 2 according to the embodiment. Accordingly, even when fuel cut is carried out during deceleration, deceleration can be generated gently, as indicated by the embodiment deceleration DEe in FIG. 11, without causing shock, which may lead to a sudden increase in rate of deceleration. As a result, fuel economy is more reliably enhanced, while shock resulting from fuel cut during deceleration is prevented.

In the foregoing vehicle control devices 2 and 90, a determination is made whether the vehicle 1 is decelerating or not based on a result detected by the acceleration sensor 55, but this may be based on the accelerator opening degree. In this case, road load when the vehicle 1 is running is estimated in a manner similar to that for estimating the gradient of a road by use of the gradient estimating unit 66, and a comparison is made between the driving force generated according to the accelerator opening degree and the road load, thereby determining whether the vehicle 1 is decelerating or not. To be specific, a threshold value is set for the accelerator opening degree, and if the accelerator opening degree, captured by the accelerator opening-degree capturing unit 62, is equal to or lower than the threshold value, the deceleration determining unit 68 determines that the vehicle 1 is decelerating. In this case, a threshold value for the accelerator opening degree is set such that driving force generated according to the accelerator opening degree matches road load estimated according to at least vehicle speed.

If the accelerator opening degree, captured by the accelerator opening-degree capturing unit 62, is equal to or lower than a degree able to generate a driving force matching the road load, the driving force generated by the driving wheels 48 is equal to or less than the road load. In this case, therefore, it can be estimated that the vehicle 1 will decelerate at a deceleration corresponding to the difference between the road load and driving force, and hence the vehicle 1 is determined to be decelerating. Thus, whether the vehicle 1 is decelerating or not is made based not on the rate at which vehicle speed changes, but on the accelerator opening degree together with road load. Accordingly, whether the vehicle 1 is decelerating or not can be determined quickly.

That is, where the determination whether the vehicle 1 is decelerating or not is made based on the rate at which vehicle speed changes, a change in vehicle speed has to be detected within a predetermined period. However, where the determination is made based on the accelerator opening degree together with road load, this determination can be made simply by comparing the accelerator opening degree with its threshold value, thus making it possible to make the determination quickly. This makes it possible quickly to determine whether the vehicle is decelerating or not where the accelerator is not fully closed. Accordingly, while the conditions for fuel cut have been satisfied, this determination can be made at an earlier stage, and fuel cut can be carried out. As a result, fuel economy is more reliably enhanced.

The foregoing vehicle control devices 2 and 90 use frictional engagement elements 40 of the transmission 30 and the lockup mechanism 27 of the torque converter as transmission state altering mechanisms. However, the transmission state altering mechanisms do not have to be these. Instead, for example, where the transmission 30 is not a step-transmission 30, which has a plurality of transmission gear stages as described above, but is a known stepless transmission, such as a so-called CVT (Continuously Variable Transmission), which is able to alter a transmission ratio continuously by transmitting power by means of a belt, a starter clutch (not illustrated) provided together with the CVT may be used. Alternatively, a starter clutch (not illustrated) provided for the torque converter 21 and disposed in series with a path used for transmitting fluid, a clutch (not illustrated) specifically provided in a power transmission path from the engine 10 to the driving wheels 48, or the like, may be used. The configuration of the transmission state altering mechanism is not restricted as long as power transmission between the engine 10 and the driving wheels 48, that is, the rate at which power is transmitted, can be altered.

### INDUSTRIAL APPLICABILITY

As described above, the vehicle control device according to the invention is useful in a vehicle control device provided for a vehicle that carries out fuel cut when decelerating, and is suitable for enhancing fuel economy.

### REFERENCE SINGS LIST

1 VEHICLE
2, 90 VEHICLE CONTROL DEVICE
10 ENGINE
15 ENGINE SPEED SENSOR
20 AUTOMATIC TRANSMISSION
21 TORQUE CONVERTER
27 LOCKUP MECHANISM
30 TRANSMISSION
46 DIFFERENTIAL DEVICE
48 DRIVING WHEELS
50 ACCELERATOR PEDAL
51 ACCELERATOR OPENING DEGREE SENSOR
55 ACCELERATOR SENSOR
60 ECU
61 PROCESSING UNIT
62 ACCELERATOR OPENING DEGREE CAPTURING UNIT
63 ENGINE SPEED CAPTURING UNIT
64 VEHICLE SPEED CAPTURING UNIT
65 ACCELERATION CAPTURING UNIT
66 GRADIENT ESTIMATING UNIT
67 IDLING-STATE DETERMINING UNIT
68 DECELERATION DETERMINING UNIT
69 GRADIENT DETERMINING UNIT
70 ACCELERATOR OPENING DEGREE DETERMINING UNIT
71 FUEL CUT CONDITION SATISFACTION DETERMINING UNIT
72 ENGINE CONTROL UNIT
73 TRANSMISSION CONTROL UNIT
80 STORAGE UNIT
81 INPUT/OUTPUT UNIT
91 MOTOR
92 MOTOR CONTROL UNIT

1. A vehicle control device comprising:
a power adjusting unit capable of adjusting power generated by an engine as a power source when a vehicle is running by adjusting degree of operation of the power adjusting unit, wherein
when the degree of operation of the power adjusting unit is other than zero and when a determination that the vehicle is decelerating is made by comparing running resistance of the running vehicle with driving force matching the degree of operation of the power adjusting unit, fuel supply stopping control, in which supply of fuel used for operating the engine is stopped, is exerted.

2. The vehicle control device according to claim 1, further comprising:
a transmission state altering mechanism capable of altering a transmission state of power between the engine and driving wheels, wherein
the transmission state altering mechanism is controlled such that when the fuel supply control is exerted, a transmission rate at which the power is transmitted between the engine and the driving wheels is decreased.

3. The vehicle control device according to claim 1, wherein when a road on which the vehicle is running is an upward slope, the fuel supply stopping control is inhibited.

4. The vehicle control device according to claim 1, wherein when the degree of operation of the power adjusting unit is increasing, the fuel supply stopping control is inhibited.

5. The vehicle control device according to claim 1, further comprising:
a transmission state altering mechanism capable of altering a transmission state of power between the engine and the driving wheels; and
a motor that is a power source for running the vehicle, wherein
when the fuel supply stopping control is exerted, the transmission state altering mechanism is controlled such that a transmission rate at which the power is transmitted between the engine and the driving wheels is decreased, and
the motor is configured such that if the transmission rate at which the power is transmitted between the engine and driving wheels is decreased by the transmission state altering mechanism during the fuel supply stopping control, with a result that rotation number of the engine has decreased to a fuel supply resuming engine speed or lower, the power required to independently operate the engine when resuming the fuel supply after the fuel supply stopping control can be transmitted to the engine.
